(19) United States
(12) Patent Application Publication
(10) Pub. No.: US 2006/0079130 A1
(43) Pub. Date: Apr. 13, 2006

(54) Power connector

(75) Inventors: AnYi Zhang, Kunsan (CN); Zhi-qiang Chen, Kunsan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/148,548

(22) Filed: Jun. 8, 2005

(30) Foreign Application Priority Data
Oct. 13, 2004 (CN) 2004200803168

(51) Int. Cl. H01R 13/648

(52) U.S. Cl. 439/607

(57) ABSTRACT

A power connector includes a housing (10), contacts (20, 30, 40) received in the housing and a shield. The housing has a front face (11), a top face (13), a bottom face (14) and two side faces (15). The shield has a front shield (50) and a U-shape rear shield (60). The front shield is formed with a fringe (53) and a pair of wings (54) bent rearwardly respectively from edges thereof. The front shield covers the front face of the housing, and the fringe and the wings respectively cling to top face and side faces of the housing. The rear shield covers the top face and two side faces of the housing, simultaneity, the rear shield further fastens the fringe and the wings of the front shield to keep the front shield on the housing and prevent the front shield from overturning outwards.

### BACKGROUND OF THE INVENTION

1. Field of the Invention

The present invention relates to a power connector and particularly to a power connector having an improved shield.

2. Description of Related Art

Power connectors are widely used in the field of electronics equipments to transmit direct current. Usually, a power connecter needs to be shielded by a shield for protecting itself against electromagnetic interference. The shield may be an integral type or a detached two-piece type due to a various configuration of the power connecter. A power connecter shielded by an integral shield is complicated in an assembly process, and this integral shield can not shield the power connecter reliably after itself being disassembled time after time, which will reduce a crippling resistance of the integral shield especially in bent portions and will even rupture the integral shield, so the detached two-piece shield is more and more popular. The detached two-piece shield comprises a front shield and a rear shield, and usually the front shield is retained only in right and left sides thereof and not retained in top and bottom sides, as a result, the front shield will occur an outwards overturn easily when the power connector is impacted by an outside force during a transportation/inserting-drawing/use process. U.S. Pat. No. 5,281,169 discloses an improved detached two-piece shield which can prevent a front shield from overturning outwards, However, accessional parts formed on each alone piece for engaging with each other are quite too much which increase difficulties in manufacture and complicate the figuration of the shield.

Hence, an improved power connector is required to overcome the disadvantages of the prior art.

### SUMMARY OF THE INVENTION

An object of the present invention is to provide a power connector shielded by a two-piece shield which is in a simple configuration and can avoid outwards overturning to get a nicer electrical signal transmission.

Accordingly, to achieve above-mentioned objects, a power connector in accordance with present invention includes a housing, a plurality of contacts received in the housing and a shield. The housing approximate has a front face, a top face and two side faces and defines a tube-like receiving chamber through the front face thereof for an insertion of a complementary connector. The shield comprises a front shield and a U-shape rear shield. The front shield is formed with a rectangle face, a fringe and a pair of wings bent rearwardly respectively from a top edge and side edges of the rectangle face. When the front shield and the rear shield are assembled on the housing, the rectangle face of the front shield covers the front face of the housing, the fringe clings to the top face of the housing, the wings cling to the side faces of the housing. And the U-shape rear shield covers the top face and the side face of the housing, simultaneity, the rear shield further covers and fastens the fringe and the wings of the front shield to keep the front shield on the housing and prevent the front shield from overturning outwards. The configuration of the shield is simple, and the front shield is protected against overturn outwards that make the power connector transmits electrical signal stably.

Other objects, advantages and novel features of the present invention will become more apparent from the following detailed description of the present embodiment when taken in conjunction exploded with the accompanying drawings.

### BRIEF DESCRIPTION OF THE DRAWINGS

FIG. 1 is an exploded perspective view of a power connector in accordance with the present invention;

FIG. 2 is a front perspective view of the power connector shown in FIG. 1;

FIG. 3 is a front exploded perspective view of the power connector shown in FIG. 1;

FIG. 4 is an cross-sectional view of a housing of the power connector along a midline of the housing;

FIG. 5 is a cross-sectional view of the power connector taken along line 5-5 of FIG. 2, which shows a shield and contacts assembled on the housing; and

FIG. 6 is a rear perspective view of the power connector taken along line 6-6 of FIG. 1.

### DETAILED DESCRIPTION OF THE INVENTION

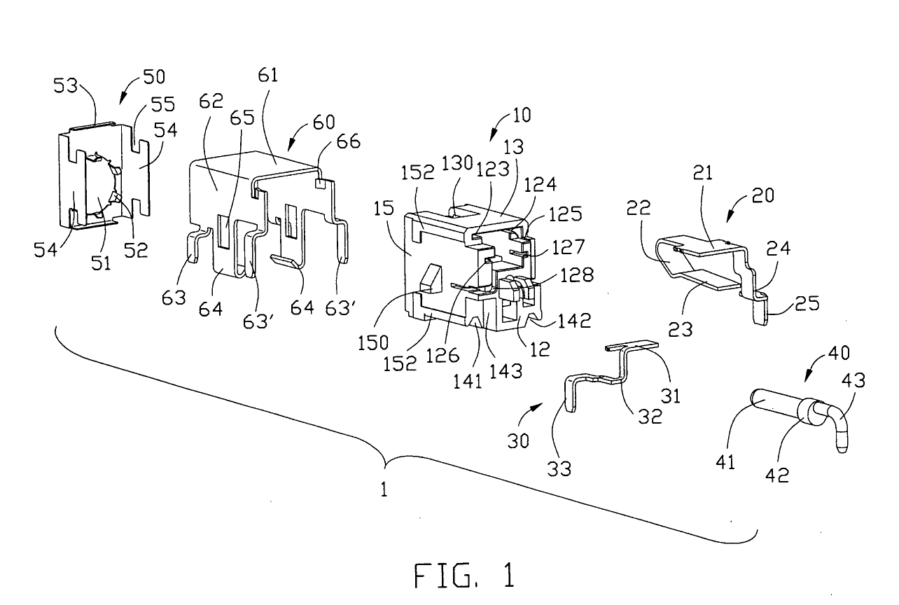

Referring to FIG. 1, a power connector 1 in accordance with the present invention comprises an housing 10, a first spring contact 20, a second spring contact 30, a central pin 40 and a shield covering the housing 10.

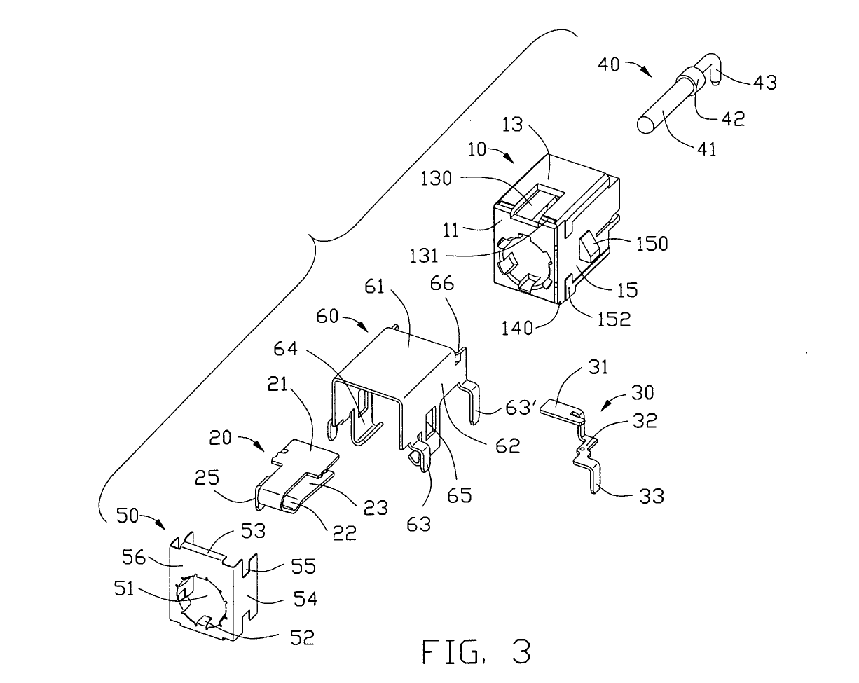

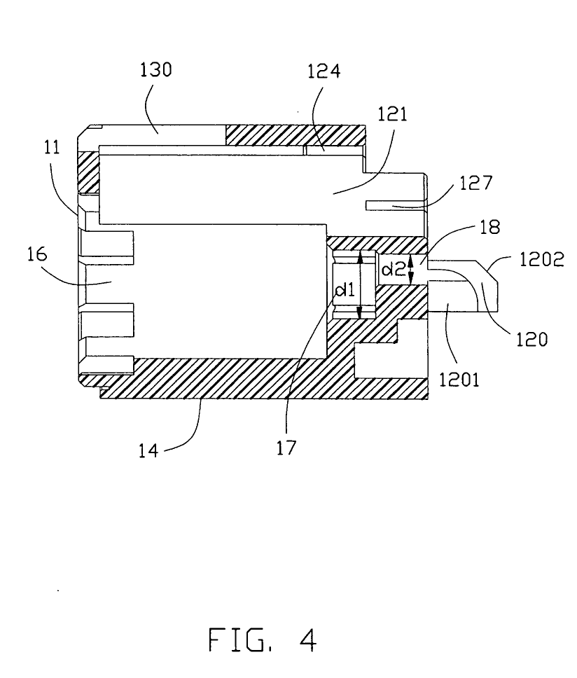

Further referring to FIG. 3 and FIG. 4, the housing 10 approximately in a shape of a cubical block has a front face 11, a rear face 12, a top face 13, a bottom face 14 and two parallel side faces 15. The housing 10 defines a tube-like receiving chamber 16 through the front face 11 thereof for an insertion of a complementary connector. The receiving chamber 16 further extends rearwardly in a smaller diameter through the rear face 12 of the housing 10 to define a front hole 17 with a diameter d1 and a rear hole 18 with a diameter d2. The d2 is smaller than the d1.

The housing 10 still defines a rectangular space 121, which is through the rear face 12 and extends upwards through the top face 13 to form an opening 130. Furthermore, the rectangular space 121 is above the receiving chamber 16 and communicates with the receiving chamber 16 downwards. The opening 130 can act as radiator for dispelling the heat during the voltage transmitting.

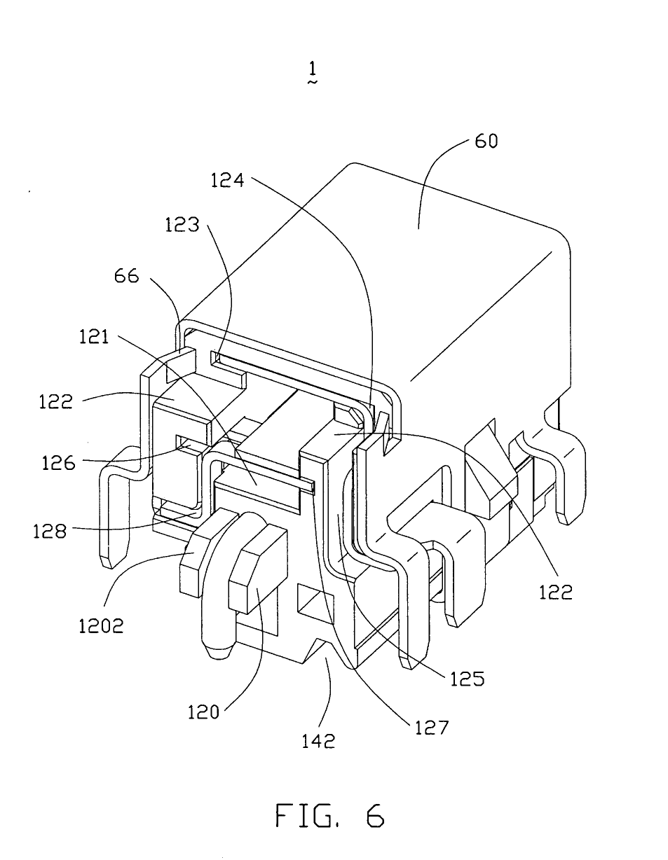

Referring to FIG. 1, a part of the top face 13 adjacent to the rear face 12 is depressed downwards to form a step face 122 parallel to the top face 13 and expose a rear portion of the rectangular space 121. The bottom face 14 defines two parallel notches 141, 142 for engaging with the shield. Referring to FIG. 3, the top face 13 and the bottom face 14 have a step portion 131, 140 at positions thereof connecting with the front face 12 respectively. Each side face 15 is formed with a pair of protruding ridges 152 and a protuberance 150 for engaging with the shield, and the protruding ridges 152 and the protuberance 150 are disposed symmetrically on the two side faces 15. Referring to FIG. 4 and FIG. 6, the rear face 12 has a pair of vertical lappets 120 extending rearwardly therefrom and disposed on opposites sides of the rear hole 18. Each lappet 120 is provided with a block 1201 on an inside face thereof and a sloping guide portion 1202 on a rear portion thereof, by such way the lappets define a channel (not labeled) therebetween communicated with the rear hole 18.

Referring to FIG. 1, the first spring contact 20 formed and shaped by a sheet metal has a horizontal body 21, a U-shape spring portion 22 bent downwards from a front edge of the body 21 with a contacting portion 23 formed on a free end thereof, a L-shape linking portion 24 bent downwards from an outside edge of the body 21 and a soldering tab 25 bent downwards from the L-shape linking portion 24. The second spring contact 30 is similar to the first spring contact 20 in structure having a horizontal body 31, an L-shape linking portion 32 and a soldering tab 33, but the second spring contact 30 has not a U-shape spring portion.

Referring to FIG. 1 and FIG. 6, the housing 10 has corresponding figures for receiving the first spring contacts 20 and the second spring contacts 30. A pair of first slots 123, 124 are defined on opposed inner sidewalls (not labeled) of a top portion of the rectangular space 121. The first slots 123, 124 are disposed in a same horizontal face and extend through the housing 10 rearwardly along a direction from the front face 11 to the rear face 12. Following, the first slot 124 extends downwards first and then outwards through a side face 15, in such way, a first L-shape groove 125 is defined in the housing 10 which is consecutive to the first slot 124.

A pair of second slots 126, 127 are defined on opposed inner sidewalls (not labeled) on the lower portion of the rectangular space 121. The second slots 126, 127 are disposed in a same horizontal face and extend through the rear face 12 of the housing 10. A strip portion on the inner bottom wall (not labeled) of the rectangular space 121 adjacent to the second slot 126 depresses downwards and then extends outwards through the other side face 15, in that way, a second L-shape groove 128 is defined in the housing opposed to the first L-shape groove 125.

In assembly, the first and the second spring contacts 20, 30 are inserted into the housing 10 from the rear face 12 to be received in the housing 10. The body 21, 31 are respectively retained in the first slots 123, 124 and the second 126, 127, the L-shape linking portion 24, 32 are received in the first L-shape groove 125 and second L-shape groove 128 with the soldering tab 25, 33 extending beyond the housing 10 for soldering to a print circuit board (not shown). In such arrangement, the contacting portion 23 is set in the rectangular space 121 and abuts against the body 31 of the second spring contact 30.

Referring to FIG. 1, a central pin 40 comprises an engaging portion 41 for engaging with the complementary connector (not shown), a retaining portion 42 and a connecting portion 43 for connecting to a print circuit board. The engaging portion 41, the retaining portion 42 and the connecting portion 43 are all in a shape of columns. A diameter of the retaining portion 42 is approximately equal to the diameter (d₂) of the front hole 17 defined in the housing 10, and a diameter of the connecting portion 43 is approximately equal to the diameter (d₁) of the rear hole 18 defined in the housing 10.

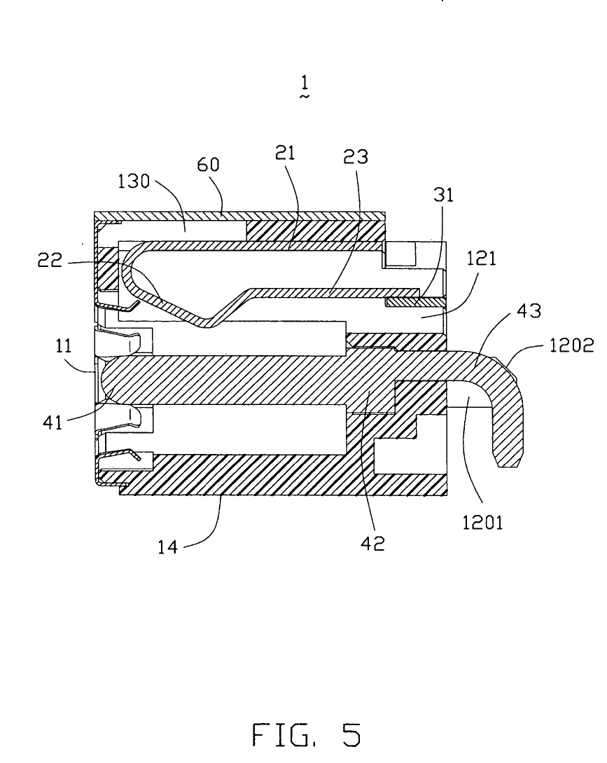

Referring to FIG. 1 and FIG. 5 together, when the central pin 40 is inserted into the receiving chamber 16 from the front face 11 of the housing 10, the connecting portion 43 protrudes out of the housing 10 passing the front hole 17 and the rear hole 18 and extends rearwardly in the channel (not labeled) defined by the lappets 120, the retaining portion 42 is retained in the front hole 17 and blocked off before the rear hole 18 for that the diameter (d₂) of the retaining portion 42 is larger than the diameter (d₁) of the rear hole 18, thus the central pin 40 is prevented from being pushed backwards while the complementary connector (not shown) being inserted into the housing 10. Then, the connecting portion 43 is bent downwards along an outside contour line of the guide portions 1202 of the lappets 120 to be warded off behind the block 1201, so that the central pin 40 is prevented from being pulled forwards together with the complementary connector (not shown) while the complementary connector being drawn out of the housing 10.

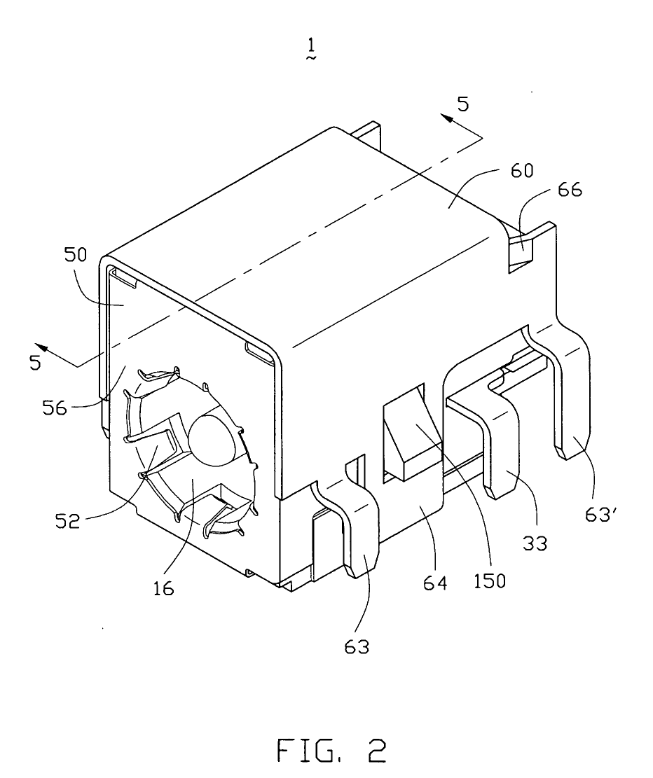

Referring to FIG. 1, FIG. 2 and FIG. 6, the shield comprises a front shield 50 and a rear shield 60. The front shield 50 is formed with a rectangle face 56, a pair of fringes 53 bent rearwardly respectively from top and bottom edges of the rectangle face 56 and a pair of wings 54 bent rearwardly respectively from right and left edges of the rectangle face 56. The rectangle face 56 is defines a hole 51 in a center thereof with a plurality of resilient flakes 52 extending inwards around the edge of the hole 51. The wings 54 each define a pair of gaps 55 thereof corresponding to the protruding ridges 101 formed on the side faces 15 of the housing 10.

When the front shield 50 mounts on the housing 10, the rectangle face 56 covers the front face 11, the fringes 53 respectively cling to the step portions 131, 140 respectively formed on the top face 13 and the bottom face 14, and the wings 54 respectively cling to the side faces 15. The slots 55 of the wings engage with the protruding ridges 152 of the side face 15 to make the front shield 50 be hold onto the housing 10. The hole 51 has a same diameter with and coaxial with the receiving chamber 16 for a free insertion of complementary connector.

The rear shield 60 is in a U-shape comprising a top wall 61 and two sidewalls 62 respectively bent downwards from lateral ends of the top wall 61. Each sidewall 62 is formed with two positioning pieces 63, 63′ and a latch piece 64 disposed between the positioning pieces 63, 63′. The positioning pieces 63, 63′ extend vertically from bottom of the two side faces 62 for positioning the rear shield 60 to the print circuit board. Each sidewall 62 has an aperture 65 and a slice 66 protruding inwards from a position near the step face 122 and against the housing 10 (Referring to FIG. 6).

When the rear shield 60 mounts on the housing 10, the top wall 61 and side walls 62 respectively covers the top face 13 and the side faces 15 of the housing 10, the apertures 65 of the sidewall 62 engage with corresponding protuberances 150 of the housing 10, and the latch pieces 64 are locked in the corresponding notches 141, 142 of the housing 10. By such way, the rear shield 60 is hold onto the housing 10 firmly. Simultaneity, the rear shield 60 further covers and fastens the fringes 53 on the top edge and the wings 54 of the front shield 50 which respectively cling to the top face 12 and side faces 15 of the housing 10.

When the power connector is impacted by an outside force during a transportation or inserting-drawing or use process, the front shield 50 will not occur an outwards overturn for that one fringe 53 and two opposed wings 54 of the front shield 50 is fastened to the housing 10 by the rear shield 60, that means three sides of the front shield 50 are retained firmly, so the power connector 1 can transmit electrical signal stably. Moreover, the configurations of the front shield 50 and the rear shield 60 are simple.

The disclosure is illustrative only, changes maybe made in detail, especially in matter of shape, size, and arrangement of parts within the principles of the invention. For example, the front shield 50 can disposed only one fringe bent from a top of the rectangle face 56.

What is claimed is:

1. A power connector comprising:
a housing having a front face, a top face, a bottom face and two opposed side faces, and the housing defining a tube-like receiving chamber through the front face thereof for an insertion of a complementary connector;
a plurality of contacts received in the housing;
a front shield having a rectangle face covering the front face of the housing, a fringe bent rearwardly from a top edge of the rectangle face to cling to the top face of the housing, and a pair of wings bent rearwardly from right and left edges of the rectangle face to cling to the side faces of the housing; and
a rear shield comprising a top wall and two opposed sidewalls, respectively covering the top face and the side faces of the housing, simultaneity, the rear shield further wrapping the fringe and the wings of the front shield clinging to the housing.

2. The power connector as described in claim 1, wherein the front shield defines a hole in a center thereof with a plurality of resilient flakes extending inwards around the edge of the hole.

3. The power connector as described in claim 2, wherein the housing has protruding ridges formed on the side faces thereof, and the front shield defines gaps formed on the wings for engaging with corresponding protruding ridge.

4. The power connector as described in claim 3, wherein the housing has protuberances formed on two side faces thereof, and the rear shield has apertures defined on side faces thereof for engaging with the protuberances on the housing.

5. The power connector as described in claim 4, wherein the rear shield has a latch pieces disposed between the positioning pieces, the housing defines notches on the bottom face thereof locking corresponding latch pieces.

6. The power connector as described in claim 5, wherein the rear shield has positioning pieces formed symmetrically on the opposed sidewalls for positioning the rear shield to the print circuit board.

7. The power connector as described in claim 6, wherein the sidewalls of the rear shield are formed with slices protruding inwards and abutting against the housing forwards.

8. The power connector as described in claim 2, wherein the top face of the housing has a step portion at a position thereof connecting with the front face, the fringe of the front shield is set on the step portion against the housing rearwadly.

9. The power connector as described in claim 8, wherein the bottom face has a step portion at a position thereof connecting with the front face, the front shield has another fringe bent rearwardly from a bottom edge of the rectangle face and set on the step portion on the bottom face against the housing rearwadly.

10. An electrical connector comprising:
an cubic insulative housing defining opposite top and bottom walls, front and rear walls and two side walls, each of said side walls further including at least one protrusion;
a mating port defined in the front wall;
a plurality of contacts disposed in the housing and communicating with the mating port;
a front metallic shield assembled to the housing along a front-to-back direction, said front metallic shield including a front face covering the front wall and defining an opening therein aligned with the mating port in said front-to-back direction, and two opposite wings covering a front portion of the corresponding side wall and extending rearwardly from two opposite side edges of the front face, each of said wings including at least one gap snugly receiving the corresponding protrusion therein so as to assure that the front metallic shield can not be forwardly move away from the housing when said wing is seated upon the corresponding side wall in a planar manner, and
a rear metallic shield including two opposite side plates covering the corresponding side wings, respectively, and further preventing the corresponding wings from being deformed or tilted away from the corresponding side walls so as to assure the front metallic shield is fastened to the housing with risks of withdrawal therefrom.

11. The connector as claimed in claim 10, wherein each of said wings defines an I-like elevational configuration.

12. The connector as claimed in claim 10, wherein the housing further includes means for locking the rear metallic shield thereto.

13. An electrical connector comprising:
an insulative housing defining opposite top and bottom walls, front and rear walls and two side walls;
a mating port defined in the front wall;
a protrusion formed on each of said side walls;
a metallic shield defining an upside-down U-shaped portion including a top face and two opposite side faces which allow the metallic shield to be downwardly assembled to the housing,
each of said side faces defining an opening receiving the corresponding protrusion therein, and a hook-like latch piece obliquely upwardly extending from a bottom edge of corresponding side face into a corresponding slanted type recess formed on a bottom portion of the housing.

14. The connector as claimed in claim 13, wherein the protrusion defines an oblique upward face to allow the metallic shield to be downwardly assembled to the housing.

15. The connector as claimed in claim 13, wherein said metallic shield further includes a slice to latchably engage a rear wall of the housing when assembled.

16. The connector as claimed in claim 13, wherein the metallic shield further includes a plurality of upside-down L-shaped mounting legs for mounting to a printed circuit board under a condition that a horizontal section of the upside-down L-shaped mounting leg seated upon an upper surface of the printed circuit board.

17. The connector as claimed in claim 16, wherein a bottom face of the protrusion is not located below the horizontal section of the upside-down L-shaped mounting leg for not interfering with the printed circuit board.
